(19) United States
(12) Patent Application Publication
(10) Pub. No.: US 2022/0237468 A1
(43) Pub. Date: Jul. 28, 2022

(54) METHODS AND SYSTEMS FOR USING MACHINE LEARNING MODELS THAT GENERATE CLUSTER-SPECIFIC TEMPORAL REPRESENTATIONS FOR TIME SERIES DATA IN COMPUTER NETWORKS

(71) Applicant: The Bank of New York Mellon, New York, NY (US)

(72) Inventors: Dong FANG, Dublin (IE); Eoin LANE, Dublin (IE)

(73) Assignee: THE BANK OF NEW YORK MELLON, New York, NY (US)

(21) Appl. No.: 17/159,868

(22) Filed: Jan. 27, 2021

(51) Int. Cl. G06N 3/08; G06F 16/2458; H04L 29/06; G06N 3/04

(52) U.S. Cl. CPC G06N 3/088; G06N 3/0454; H04L 63/1408; G06F 16/2474

(57) ABSTRACT

The systems and methods provide a machine learning model that can exploit long time dependency for time-series sequences, perform end-to-end learning of dimension reduction and clustering, or train on long time-series sequences with low computation complexity. For example, the methods and systems use a novel, unsupervised temporal representation learning model. The model may generate cluster-specific temporal representations for long-history time series sequences and may integrate temporal reconstruction and a clustering objective into a joint end-to-end model.

### FIELD OF THE INVENTION

Embodiments of the invention generally relate to using machine learning models that generate cluster-specific temporal representations for time series data.

### BACKGROUND

In conventional computer systems, operations and results are often produced by computing systems across multiple assets, applications, domains, and/or networks. Any change made, process performed, and/or result produced by any of these individually may influence all of them in the aggregate. These aggregate effects are even more striking when the multiple assets, applications, domains, and/or networks are organized into clusters based on similar characteristics and/or previous results. For example, the performance and/or results produced by one asset, application, domain, and/or network may be similar to that produced by another.

### SUMMARY

Accordingly, methods and systems are described herein for generating alerts based on the performance and/or results produced by one asset, application, domain, and/or network which may be similar to that produced by another. More particularly, methods and systems are described herein for generating alerts based on cluster-specific temporal representations for time series data through the use of machine learning models. For example, while clustering and machine learning techniques have been successfully applied to static data, applying these approaches to data with a temporal element (e.g., time series data) have not yet been successful. Therefore, for practical applications featuring a temporal element, conventional techniques are not suitable.

For example, the systems and methods may generate network alerts (e.g., indicating network traffic congestion, hardware failures, and/or processing bottlenecks) based on the throughput of one domain. However, the system may need a mechanism for determining what the throughput should be at any given time (e.g., what would be the throughput without congestion, hardware failures, etc.). Determining this ideal throughput may be difficult as the throughput may depend on numerous factors (e.g., a time of day, a current number or size of processing tasks, and/or historical trends) and these factors may not be immediately discernable. Accordingly, the system identifies a cluster of similar domains to which the domain corresponds. For example, the system may cluster these domains based on historical trends in their throughput. The system may then determine based on the average throughput of the cluster of domains whether or not the cluster is likely experiencing an issue with throughput. Based on this likelihood, the system may generate an alert.

In another example, the systems and methods may generate network alerts (e.g., indicating abrupt changes, likely changes, and/or other discrepancies in one or more values) based on changes of a metric (e.g., a value associated with a one domain). However, the system may need a mechanism for determining what the metric should be at any given time (e.g., what would be the metric prior to the abrupt changes, likely changes, and/or other discrepancies in one or more values). Determining this ideal metric may be difficult as the value may depend on numerous factors as discussed above. Accordingly, the system identifies a cluster of similar domains to which the domain corresponds as described above and determine an average value for the cluster of domains. Based on discrepancies in the values (e.g., a difference between the value and the average value beyond a threshold amount), the system may trigger an alert.

However, generating alerts based on cluster-specific temporal representations for time series data through the use of machine learning models is not without its technical hurdles. For example, time series data from different domains exhibit considerable variations in important properties and features, temporal scales, and dimensionality. Further, time series data from real world applications often have temporal gaps as well as high frequency noise due to the data acquisition method and/or the inherent nature of the data. Accordingly, conventional clustering techniques are not applicable.

For example, conventional clustering algorithms (e.g., based on K-mean and hierarchal clustering) requires dimension reduction for long sequences (e.g., in order to process historic trends) and loses time dependency. Accordingly, they cannot capture the time dependency and dynamic relationships. In another example, deep learning based clustering algorithms cannot capture the time dependency, cannot exploit the very long history dependency (e.g., LSTM-autoencoder with DEC), and are hard to train (e.g., a LSTM-autoencoder).

PATENT

In view of these technical hurdles, the systems and methods provide a machine learning model that can exploit long time dependency for time-series sequences, perform end-to-end learning of dimension reduction and clustering, or train on long time-series sequences with low computation complexity. For example, the methods and systems use a novel, unsupervised temporal representation learning model. The model may generate cluster-specific temporal representations for long-history time series sequences and may integrate temporal reconstruction and a clustering objective into a joint end-to-end model.

Specifically, the model may adapt two temporal convolutional neural networks as an encoder portion and decoder portion, enabling a learned representation (e.g., a reconstruction) to capture the temporal dynamics and multi-scale characteristics of inputted time series data. The model may also cluster domains within a network and detect outliers of time series data based on the learned representation forms and a cluster structure featuring the guidance of the Euclidean distance objective.

In some aspects, the systems and methods for generating network alerts are based on detected variances in trends of domain traffic over a given time period for disparate domains in a computer network using machine learning models that generate cluster-specific temporal representations for time series sequences. For example, the system may receive first time series data for a first domain for a first period of time. The system may generate a first feature input based on the first time series data. The system may input the first feature input into an encoder portion of a machine learning model to generate a first latent representation, wherein the encoder portion of the machine learning model is trained to generate latent representations of inputted feature inputs. The system may input the first latent representation into a decoder portion of the machine learning model to generate a first reconstruction of the first time series data, wherein the decoder portion of the machine learning model is trained to generate reconstructions of inputted feature inputs. For example, the system may input the first latent representation into a clustering layer of the machine learning model to generate a first clustering recommendation for the first domain, wherein the clustering layer of the machine learning model is trained to cluster domains based on respective time series data. The system may generate for display, on a user interface, a network alert based on the first reconstruction and the first clustering recommendation.

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 depicts a user interface that generates alerts using machine learning models that generate cluster-specific temporal representations for time series data, in accordance with an embodiment.

FIG. 2 depicts illustrative diagrams for generating alerts using machine learning models that generate cluster-specific temporal representations for time series data, in accordance with an embodiment.

FIG. 3 depicts an illustrative system for generating alerts using machine learning models that generate cluster-specific temporal representations for time series data, in accordance with an embodiment.

FIG. 4 depicts an illustrative model architecture for generating alerts using machine learning models that generate cluster-specific temporal representations for time series data, in accordance with an embodiment.

FIG. 5 depicts a process for generating alerts using machine learning models that generate cluster-specific temporal representations for time series data, in accordance with an embodiment, in accordance with an embodiment.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details, or with an equivalent arrangement. In other cases, well-known structures and devices are shown in block diagram form in order to avoid unnecessarily obscuring the embodiments of the invention.

The systems and methods described herein may be implemented in numerous practical applications. For example, the advantages described herein for using machine learning models that generate cluster-specific temporal representations for time series data may be applicable to any time series data (or data with a temporal element and/or data that is represented as a function of time). In particular, the systems and methods are applicable to practical applications in which historical trends of different assets, applications, domains, and/or networks may be clustered together based on the historical trends and differences between values for a given asset, application, domain, and/or network in the cluster and the average values of the cluster may be of interest.

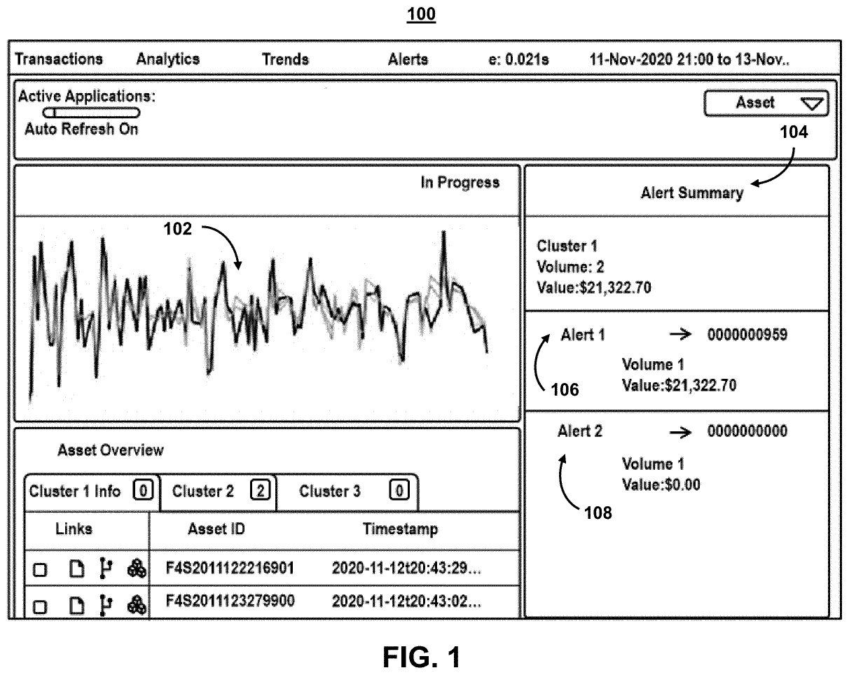

FIG. 1 depicts user interface 100 that generates alerts using machine learning models that generate cluster-specific temporal representations for time series data, in accordance with an embodiment. For example, user interface 100 may monitor time series data (e.g., time series data 102) and may generate an alert summary (e.g., alert 104) that includes one or more alerts (e.g., alert 106 and alert 108). The one or more alerts may indicate changes and/or irregularities in time series data 102 (e.g., in comparison with other time series data for other domains within the same cluster of a plurality of clusters). User interface 100 may also indicate other information about a domain and/or time series data. The one or more alerts may also include a rationale and/or information regarding why an alert was triggered (e.g., the one or more metrics and/or threshold differences that caused the alert). As referred to herein, an alert may include any communication of information that is communicated to a user. For example, an alert may be any communication that conveys danger, threats, or problems, typically with the intention of having it avoided or dealt with. Similarly, an alert may be any communication that conveys an opportunity and/or recommends an action.

User interface 100 may allow a user to view and/or respond to the one or more alerts. For example, user interface 100 may allow a user to forward information (e.g., alert summary 104) and/or one or more alerts to one or more additional users. For example, the systems and methods may generate network alerts based on the metrics of one domain. It should be noted that as referred to herein, a domain may include a computer domain, a file domain, an internet domain, a network domain, or a windows domain. It should also be noted that a domain may comprise, in some embodiments, other material or immaterial objects such as an account, collateral items, warehouses, etc. For example, a domain may comprise any division and/or distinction between one or more products or services, and domain traffic may comprise information about those divisions and/or distinctions between one or more products or services. For example, in some embodiments, a domain may comprise, or correlate to a financial service, account, fund, or deal. Accordingly, time series data for each domain may include values, metrics, characteristics, requirements, etc. that correspond to the financial service, account, fund, or deal. For example, if the domain corresponds to a financial service, contract, or other deal, the time series data may comprise values related to the service, fund, or deal. For example, in some embodiments, where a domain comprises, or correlates to, a financial service, fund, or deal, the time series data may comprise one or more material or immaterial products or services and/or a price or value for the product or service.

As one such example, the systems and methods may correspond to a net asset value (“NAV”) of a mutual fund (e.g., a domain) as it moves dynamically on a daily basis within a market (e.g., a network). The history of NAV movements forms a time-series sequence (e.g., time series data). Those funds with similar NAV movements may be grouped together as siblings in a cluster and their group behavior may follow a similar fashion. Any deviation of a fund within the group of siblings may be considered as anomalous and trigger a network alert. Accordingly, the system may detect and investigate any irregular NAV movement of a fund (e.g., a fund's NAV increased by 15% on a given day while the average of the sibling funds moved up by 7.5%). The system may then use this alert to determine whether there is a potential error on the NAV calculation.

For example, the systems and methods may generate network alerts (e.g., indicating abrupt changes, likely changes, and/or other discrepancies in one or more values) based on changes of a metric (e.g., a value associated with a one domain). Accordingly, the system identifies the cluster of similar domains to which the domain corresponds as described above and determines an average value for the cluster of domains. Based on discrepancies in the values (e.g., a difference between the value and the average value beyond a threshold amount), the system may trigger an alert.

The distinctions of a network, domain, and/or network alert may be applied to multiple embodiments. For example, a network may be a collection of domains, and a network alert may be an alert about activity in the network (e.g., the collection of domains). The alert may comprise time series data about a metric, value, and/or other type of information about one or more domains. For example, the systems and methods may be used to detect price fluctuations based on time series data (e.g., triggering a network alert) for a domain (e.g., a fund) in a network (e.g., a group of funds). In another example, the systems and methods may be applied to air pollution analysis. For example, sensors (e.g., domains) in a city (e.g., a network) may collect multiple air condition records (e.g., time series data). The systems and methods may help to determine the community properties of air pollution.

In another example, the systems and methods may be applied to utility data analysis. For example, a smart meter reading device (e.g., a domain) may continuously monitor utility data (e.g., time series data) in an area (e.g., a network). The time series clustering and representation learning could facilitate the detection of anomalies (e.g., triggering a network alert) such as leakage or node failure. In another example, the systems and methods may be applied to health data analysis. For example, wearable devices (e.g., domains) may continuously monitor costumers' (e.g., a network) health status (e.g., time series data). The systems and methods may help to determine undiscovered health conditions.

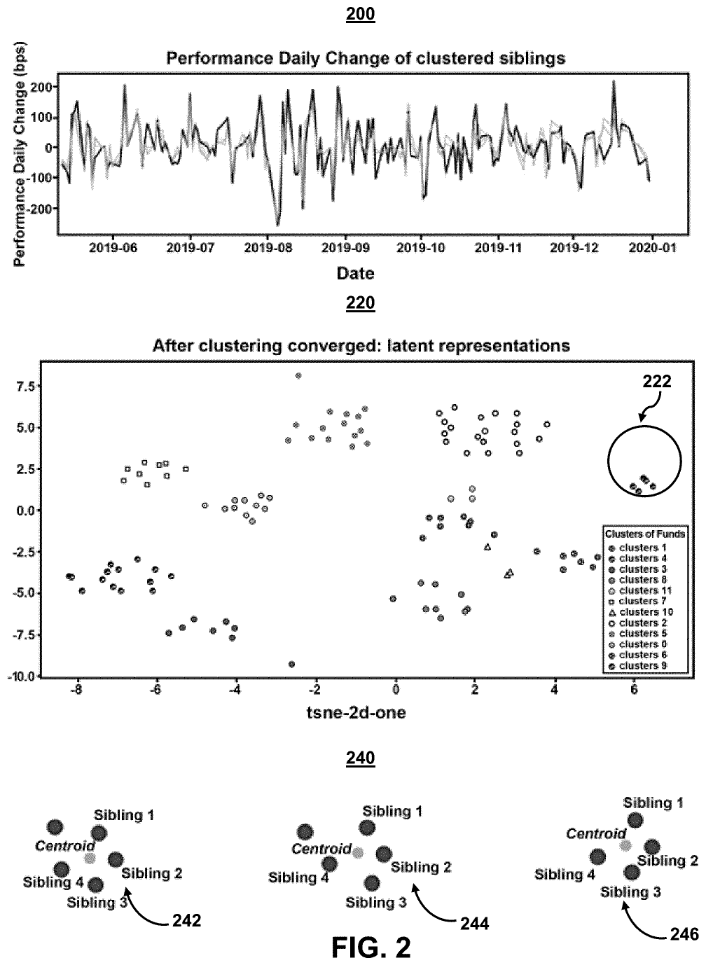

FIG. 2 depicts illustrative diagrams for generating alerts using machine learning models that generate cluster-specific temporal representations for time series data, in accordance with an embodiment. For example, FIG. 2 includes time series data 200. For example, the system may use time series data 200 to generate alerts using machine learning models that generate cluster-specific temporal representations for time series data 200. Time series data 200 may include a series of data points indexed (or listed or graphed) in time order. Time series data 200 may be a sequence taken at successive equally spaced points in time (e.g., time series data 200 may be a sequence of discrete-time data).

For example, the system may receive time series data 200 for a first domain for a first period of time. For example, time series data 200 may comprise a sequence of values corresponding to the first domain in which the sequence of values is a function of time (e.g. sequences of fund performances and other related information). For example, the system may receive a data file comprising the time series data 200 in which a value corresponding to the first domain is indexed according to a time or clock value.

For example, time series data 200 may comprise funds plotted in a year-long time series featuring their daily returns, which may be similar. To represent this similarity, the system may perform dimensional reductions on time series data 200 and as this two-dimensional system evolves over time, the system may flag a fund if its movement is different from the average movement of its siblings on a given day.

FIG. 2 also includes chart 220. Chart 220 may include one analysis of time series data 200. For example, the system may analyze the time series data using frequency-domain methods or time-domain methods. In time-domain methods, correlation and analysis may be made in a filter-like manner using scaled correlation, thereby mitigating the need to operate in the frequency domain. Chart 220 may also indicate a scatter plot of time series data (or latent representations of time series data) for one or more domains at a given point in time.

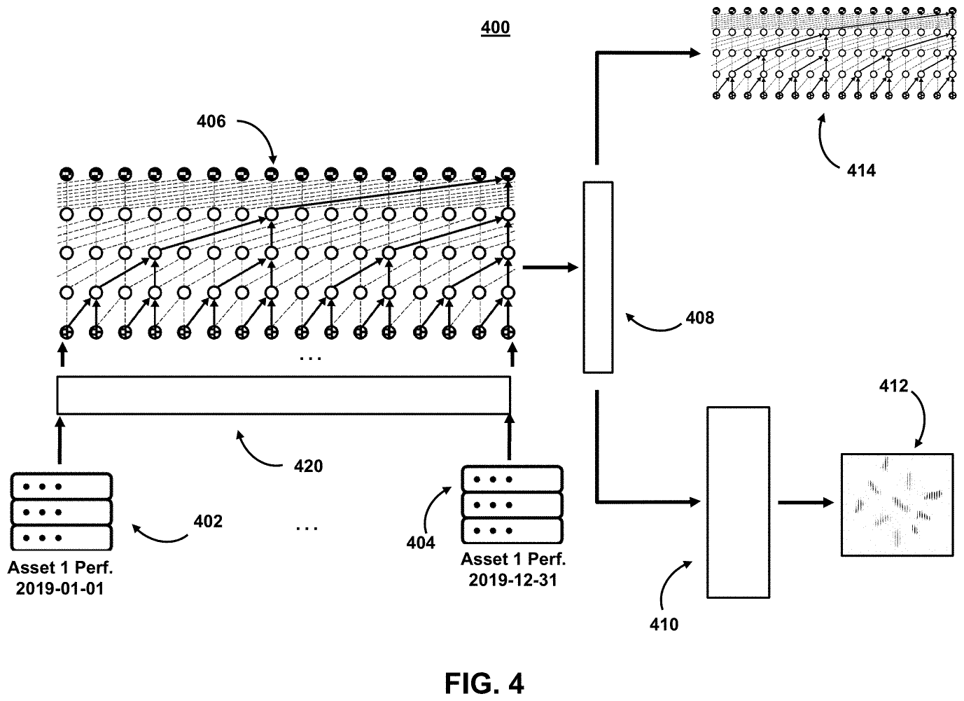

For example, the system may generate a first feature input based on the time series data 200. The feature input may be a two-dimensional (or reduced dimensionality) representation of time series data 200. The system may then input the first feature input into an encoder portion of a machine learning model to generate a first latent representation. For example, the encoder portion of the machine learning model may be trained to generate latent representations of inputted feature inputs. For example, the time series data may be fed into a temporal convolutional network (“TCN”) which has an autoencoder architecture (e.g., as described in FIG. 4). The TCN may form an encoder of the autoencoder to reduce the dimension of fund sequences and generate a latent representation of it. It should be noted that in some embodiments, the system may comprise an autoencoder constructed using a convolutional neural network (“CNN”), a causal sequence CNN, or a TCN. For example, the use of a CCN, a causal sequence CNN, or a TCN, as opposed to recurrent neural networks (“RNNs”) for representing sequences, provides advantages such as parallelization (e.g., a RNN needs to process inputs in a sequential fashion, one time-step at a time, whereas a CNN can perform convolutions across the entire sequence in parallel). Additionally, a CNN is less likely to be bottlenecked by the fixed size of the CNN representation, or by a distance between a hidden output and an input in long sequences (e.g., which may be required to detect historical trends) because in CCNs the distance between the output is determined by the depth of the network and is independent of the length of the sequence.

For example, the system may compare multiple long-term and/or historical trends for a plurality of domains. The system may use time series data 200 and/or a plurality of instances (e.g., corresponding to a plurality of charts) in which each instance represents a different point in time of the time series data 200.

The system may further comprise a cluster layer that identifies cluster 222 (e.g., the domains may correspond to clustering recommendations for cluster 222). For example, the system may perform a cluster analysis on chart 220 (or the data therein) and/or on time series data 200. The system may group a set of objects in such a way that objects in the same group (e.g., a cluster) are more similar (in some sense) to each other than to those in other groups (e.g., in other clusters). Cluster 222 may include a cluster that comprises a plurality of siblings (e.g., domains found within the cluster).

The system may compare data from multiple clusters in a variety of ways in order to determine whether or not to generate a network alert. For example, the system may average reconstructions of time series data for a cluster and compare it to reconstructions of time series data for a single domain within the cluster. In another example, the system may compare reconstructions of time series data for one domain to another. The system may then determine whether or not the difference equals or exceeds a threshold difference. In some embodiments, the system may determine the threshold difference based on one or more factors.

These factors may be static (e.g., correspond to a predetermined value selected based on a type of domain and/or cluster) or may be dynamic. For example, the threshold may vary based on the length of time reconstructions of time series data are outside another threshold distance. Additionally or alternatively, the threshold may be based on the amount of time series data, a level of noise in the time series data, and/or a level of variance between other reconstructions of time series data for other domains in the cluster.

In another example, the system may determine a centroid value of a cluster based on reconstructions of time series data for domains in the cluster. For example, the centroid or geometric center of a plane figure is the arithmetic mean position of all the points in the figure. The system may use the centroid for the reconstructions of time series data because the time series data has been dimensionally reduced (e.g., to two dimensional data) in a latent representation.

For example, the system may determine a first distance of the first reconstruction from the centroid value. The system may compare the first distance to a threshold distance. The system may determine to generate for display the network alert based on the first distance equaling or exceeding the threshold distance. Additionally or alternatively, the system may determine a second distance of the second reconstruction from the centroid value. The system may compare the second distance to the threshold distance. The system may determine not to generate for display the network alert based on the second distance not equaling or exceeding the threshold distance.

The system may use multiple functions for determining a distance. For example, the distance may be based on a Euclidean distance objective. For example, the centroid of a finite set of k points of X₁, X₂, . . . Xₖ in Rⁿ is:

$$C = \frac{{x}_{1} + {x}_{2} + … + {x}_{k}}{k}$$

This point minimizes the sum of squared Euclidean distances between itself and each point in the set. Alternatively, the system may determine the centroid based on geometric decomposition. For example, the centroid of a plane figure X can be computed by dividing it into a finite number of simpler figures X₁, X₂, . . . Xₙ, computing the centroid Cᵢ and area Aᵢ of each part, and then computing:

$${C}_{x} = \frac{\sum {C}_{{i}_{x}} {A}_{i}}{\sum {A}_{i}} , {C}_{y} = \frac{\sum {C}_{{i}_{y}} {A}_{i}}{\sum {A}_{i}}$$

FIG. 2 also includes clusters 240. Clusters 242, 244, and 246 may each correspond to a cluster found in chart 220. Additionally or alternatively, clusters 242, 244, and 246 may correspond to different groups of domains. The system may analyze each cluster to identify outliers and/or threshold distances of a value (e.g., reconstruction of time series data). The system may determine a distance for each reconstruction of time series data from the centroid of a respective cluster to determine whether or not to generate an alert for a domain corresponding to the respective reconstruction of time series data.

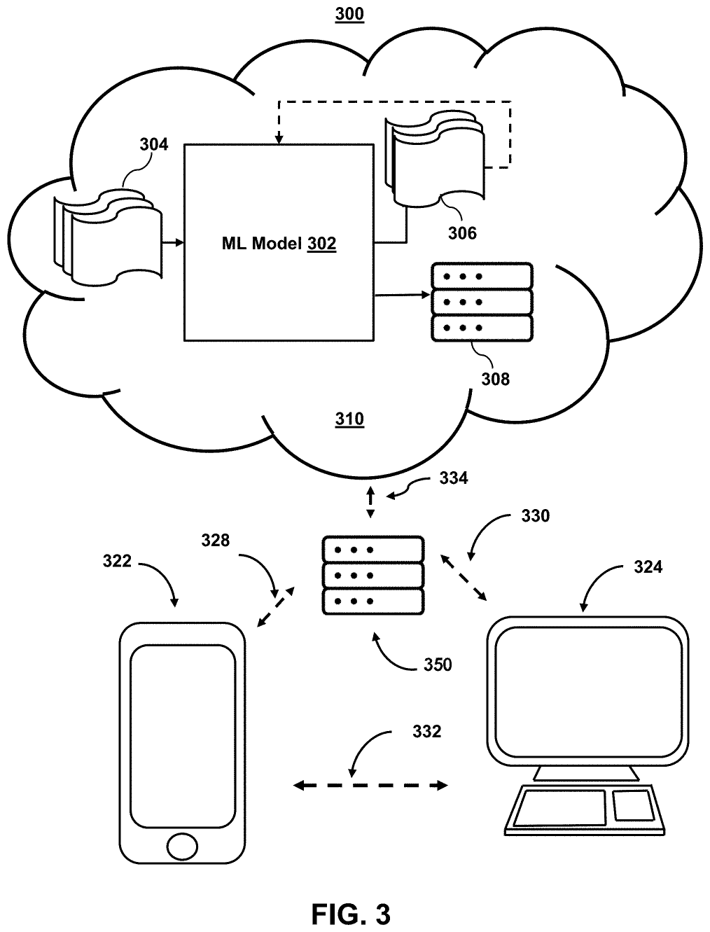

FIG. 3 depicts an illustrative system for generating alerts using machine learning models that generate cluster-specific temporal representations for time series data, in accordance with an embodiment. As shown in FIG. 3, system 300 may include user device 322, user device 324, and/or other components. Each user device may include any type of mobile terminal, fixed terminal, or other device. Each of these devices may receive content and data via input/output (hereinafter “I/O”) paths and may also include processors and/or control circuitry to send and receive commands, requests, and other suitable data using the I/O paths. The control circuitry may be comprised of any suitable processing circuitry. Each of these devices may also include a user input interface and/or display for use in receiving and displaying data.

Users may, for instance, utilize one or more of the user devices to interact with one another, one or more servers, or other components of system 300. It should be noted that, while one or more operations are described herein as being performed by particular components of system 300, those operations may, in some embodiments, be performed by other components of system 300. As an example, while one or more operations are described herein as being performed by components of user device 322, those operations may, in some embodiments, be performed by components of user device 324. System 300 also include cloud-based components 310, which may have services implemented on user device 322 and user device 324, or be accessible by communication paths 328, 330. 332, and 334, respectively. System may receive time series data from servers (e.g., servers 308). It should also be noted that the cloud-based components in FIG. 3 may alternatively and/or additionally be non-cloud-based components. Additionally or alternatively, one or more components may be combined, replaced, and/or alternated. For example, system 300 may include databases 304, 306, and server 308, which may provide data to server 302.

System 300 may also include a specialized network alert server (e.g., network alert server 350), which may act as a network gateway, router, and/or switches. Network alert server 350 may additionally or alternatively include one or more components of cloud-based components 310 for generating alerts using machine learning models that generate cluster-specific temporal representations for time series data domains (e.g., server 308). Network alert server 350 may comprise networking hardware used in telecommunications for telecommunications networks that allows data to flow from one discrete domain to another. Network alert server 350 may use more than one protocol to connect multiple networks and/or domains (as opposed to routers or switches) and may operate at any of the seven layers of the open systems interconnection model (OSI). It should also be noted that the functions and/or features of network alert server 350 may be incorporated into one or more other components of system 300, and the functions and/or features of system 300 may be incorporated into network alert server 350.

Each of these devices may also include memory in the form of electronic storage. The electronic storage may include non-transitory storage media that electronically stores information. The electronic storage of media may include (i) system storage that is provided integrally substantially non-removable) with servers or client devices and/or (ii) removable storage that is removably connectable to the servers or client devices via, for example, a port (e.g., a USB port, a firewire port, etc.) or a drive (e.g., a disk drive, etc.). The electronic storages may include optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications network or combinations of communications networks. Communication paths 328, 330, and 332 may include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

FIG. 4 depicts an illustrative model architecture for generating alerts using machine learning models that generate cluster-specific temporal representations for time series data, in accordance with an embodiment. For example, system 400 is a machine learning model that maintains a time dependency for the time series data. For example, system 400 may comprise an autoencoder constructed using a TCN. For example, the autoencoder is a neural network that learns to copy its input (e.g., time series data) to its output (e.g., reconstructions of (e.g., time series data). It has internal (hidden) layers that describes a code used to represent the input, and it is constituted by two main parts: an encoder that maps the input into the code, and a decoder that maps the code to a reconstruction of the original input.

For example, system 400 may include encoder 406. Encoder 406 may process time series data (e.g., data 402 and data 404) that corresponds to different points in time. Encoder 406 may process the time series data using a TCN. For example, encoder 406 may use causal convolutions. For example, encoder 406 may include convolutional filters applied to a sequence in a left-to-right fashion in which encoder 406 emits a representation at each step as it traverses layers (e.g., shown vertically in encoder 406). Encoder 406 is casual in that its output at time, t, is conditional on input up to, t−1, which is necessary to ensure that encoder 406 does not have access to the elements of the preceding. This feature of encoder 406 maintains a time dependency for the time series data.

In some embodiments, encoder 406 may receive time series data (e.g., data 402 and data 404 as well as time series data for point in between) after it has been processed using position encoder 420. For example, position encoder 420 may perform a position embedding/encoding step. For example, while position embedding may be performed in for word sequencing for natural language processing steps, the application of this step to the present environment allows for the TCN to process data in a sequential manner. For example, each value of time series data simultaneously flows through the encoder and decoder stack. Accordingly, the model does not have an interpretation of any sense of a position/order for each value. Position encoder 420 provides this by a generating a d-dimensional vector that contains information about a specific position in the time series data for a value. Additionally or alternatively, this encoding is not integrated into the model itself. Instead, the generated vector may be used to annotate each value with information about its position in the time series data (e.g., enhancing the model's input).

The use of a TCN as opposed to recurrent neural networks (“RNNs”) for representing sequences provides advantages such as parallelization (e.g., a RNN needs to process inputs in a sequential fashion, one time-step at a time, whereas a TCN can perform convolutions across the entire sequence in parallel). Additionally, a TCN is less likely to be bottlenecked by the fixed size of the RNN representation, or by a distance between a hidden output and an input in long sequences (e.g., which may be required to detect historical trends) because in TCNs the distance between the output is determined by the depth of the network and is independent of the length of the sequence.

Encoder 406 may include embedding layers for input and output. Additionally, the weights of the input and output embedding layers may be tied so that the representation used by an item when encoding the sequence is the same as the one used in prediction. Encoder 406 may also include stacked TCNs using Tanh or RELU non-linearities such that the sequence is appropriately padded to ensure that future elements of the sequence are never in the receptive field of the network at a given time. Encoder 406 may also include residual connections between all layers, and kernel size and dilation may be specified separately for each stacked convolutional layer.

Encoder 406 may be trained using implicit feedback losses, including pointwise (logistic and hinge) and pairwise (BPR as well as WARP-like adaptive hinge) losses. The loss may be computed for all the time steps of a sequence in one pass. For example, for all timesteps t in the sequence, a prediction using elements up to t−1 is made, and the loss is averaged along both the time and the minibatch axis, which may lead to significant training speed-ups relative to only computing the loss for the last element in the sequence.

Encoder 406 outputs latent representation 408. For example, latent representation 408 contains all the important information needed to represent the time series data (e.g., noise and/or unnecessary information is removed). For example, system 400 (e.g., via encoder 406) learns the data features of the time series data and simplifies its representation to make it less processing intensive to analyze. For example, because system 400 is required to reconstruct the compressed data (e.g., latent representation 408) using decoder 414, system 400 must learn to store all relevant information and disregard the noise.

Latent representation 408 may then be input into decoder 414 in order to generate reconstructions of the time series data. In some embodiments, decoder 414 may resemble the structure of encoder 406. For example, system 400 may comprise a stacked autoencoder such that the number of nodes per layer decreases with each subsequent layer of encoder 406 and increases back in decoder 414. Additionally or alternatively, decoder 414 may be symmetric to encoder 406 in terms of layer structure. Decoder 414 may be trained on an unlabeled dataset as a supervised learning problem to output a reconstruction of the original input (e.g., time series data). System 400 may be trained by minimizing a reconstruction error, which measures the differences between the original input and the consequent reconstruction. For example, system 400 may evaluate the output by comparing the reconstructed time series data with the original time series data (or specific points, time periods, etc.), using a Mean Square Error (“MSE”). Accordingly, system 400 would determine the more similar the reconstructed time series data is with the original time series data, the smaller the reconstruction error.

For example, system 400 may input latent representation 408 into decoder 414 of the autoencoder to generate a reconstruction of inputted time series data. For example, decoder 414 may be trained to generate reconstructions of inputted feature inputs. For example, the feature inputs may be vectors of values that correspond to time series data for one or more domains. In a practical example, latent representation 408 may be a fund sequences that may be fed into decoder 414 of a TCN to reconstruct original fund sequences and related information.

Latent representation 408 may also be inputted into cluster layer 410. For example, system 400 may use a clustering operation that provides high intra-class similarity (e.g., such that there is cohesion within clusters) and low inter-class similarity (e.g., such that there is distinctiveness between clusters). For example, by training system 400 (e.g., encoder 406), system 400 has learned to compress time series data into latent representation 408. The system may then use k-means clustering to generate cluster centroids (e.g., as described in FIG. 2) at cluster layer 410.

For example, k-means clustering partitions n observations into k clusters (e.g., clusters 412) in which each observation belongs to the cluster with the nearest mean (cluster centers or cluster centroid). This results in a partitioning of the data space into Voronoi cells. The k-means clustering minimizes within-cluster variances (e.g., squared Euclidean distances). In some embodiments, system 400 may using k-medians and k-medoids for clustering. Cluster layer 410 may therefore have weights that represent the cluster centroids, which can be initialized by training. For example, cluster layer 410 may be a stacked clustering layer after the pre-trained encoder (e.g., encoder 406) to form a clustering model. Cluster layer 410 may initialize its weights and the cluster centers using k-means trained on feature vectors of training data.

In some embodiments, system 400 may improve its clustering and generation of latent representations simultaneously. For example, system 400 may define a centroid-based target probability distribution and minimize its Kullback-Leibler (“KL”) divergence against a clustering result. By doing so, system 400 strengthens predictions, emphasizes data points assigned with high confidence, and prevents large clusters from distorting the hidden feature space. A target distribution may be computed by first raising q (the encoded feature vectors) to the second power and then normalizing by frequency per cluster. System 400 may then iteratively refine the clusters (e.g., cluster 412) by learning from the high confidence assignments with the help of the auxiliary target distribution. After a specific number of iterations, the target distribution is updated, and clustering later 410 is trained to minimize the KL divergence loss between the target distribution and the clustering output. For example, system 400 may use an initial classifier and an unlabeled dataset, then label the dataset with the classifier to train on its high confidence predictions. Additionally, system 400 may use a loss function to measure a difference between two different distributions. System 400 may minimize it so that the target distribution is as close to the clustering output distribution as possible.

Accordingly, system 400 provides a machine learning model that can exploit long time dependency for time-series sequences, perform end-to-end learning of dimension reduction and clustering, or train on long time-series sequences with low computation complexity. System 400 may generate cluster-specific temporal representations for long-history time series sequences and may integrate temporal reconstruction and a clustering objective into a joint end-to-end model. System 400 may adapt two temporal convolutional neural networks as an encoder portion and decoder portion, enabling a learned representation (e.g., a reconstruction) to capture the temporal dynamics and multi-scale characteristics of inputted time series data. System 400 may also cluster domains within a network and detect outliers of time series data based on the learned representation forms and a cluster structure featuring the guidance of the Euclidean distance objective.

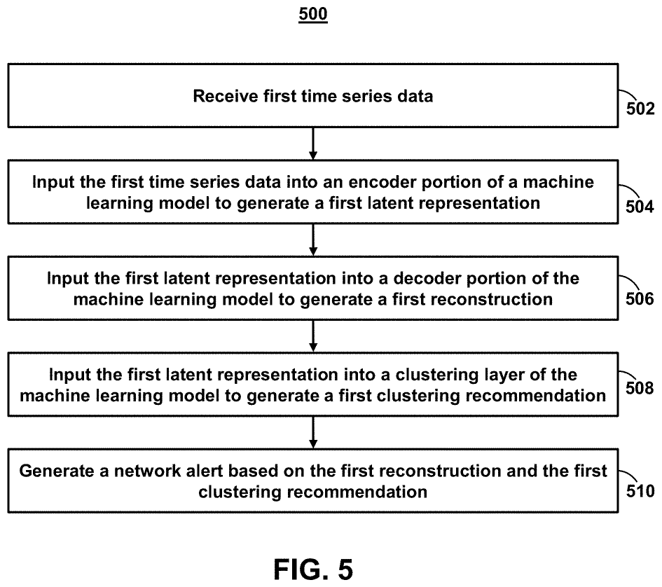

FIG. 5 depicts a process for generating alerts using machine learning models that generate cluster-specific temporal representations for time series data, in accordance with an embodiment. For example, FIG. 5 shows process 500, which may be implemented by one or more devices. The system may implement process 500 in order to generate one or more of the user interfaces (e.g., as described in FIG. 1). Furthermore, process 500 describes a machine learning model that maintains a time dependency for the first time series data. For example, the machine learning model may comprise an autoencoder constructed using a causal sequence convolutional neural network.

For example, process 500 (as well as other embodiments described herein) may be used to generate alerts based on reconstructions of time series data. For example, the reconstructions of time series data for a plurality of domains may be clustered together. Variations in the reconstructions of time series data for one cluster from the other clusters may automatically trigger an alert. This provides additional lead time to resolve, and in some cases the only warning, of a potential problem.

At step 502, process 500 (e.g., using control circuitry and/or one or more components described in FIGS. 1-4) receives first time series data. For example, the system may receive first time series data for a first domain for a first period of time. For example, the first time series data may comprise a sequence of values corresponding to the first domain in which the sequence of values is a function of time (e.g. sequences of fund performances and other related information). For example, the system may receive a data file comprises the time series data in which a value corresponding to the first domain is indexed according to a time or clock value.

At step 504, process 500 (e.g., using control circuitry and/or one or more components described in FIGS. 1-4) inputs the first time series data into an encoder portion of a machine learning model to generate a first latent representation. For example, the system may generate a first feature input based on the first time series data. The system may then input the first feature input into an encoder portion of a machine learning model to generate a first latent representation. For example, the encoder portion of the machine learning model may be trained to generate latent representations of inputted feature inputs. For example, the time series data may be fed into a TCN which has an autoencoder architecture. The TCN may form an encoder of the autoencoder to reduce the dimension of fund sequences and generate a latent representation of it.

At step 506, process 500 (e.g., using control circuitry and/or one or more components described in FIGS. 1-4) inputs the first latent representation into a decoder portion of the machine learning model to generate a first reconstruction. For example, the system may input the first latent representation into a decoder portion of the machine learning model to generate a first reconstruction of the first time series data. For example, the decoder portion of the machine learning model may be trained to generate reconstructions of inputted feature inputs. For example, the latent representation of a fund sequences may be fed into decoder structure formed by the TCN to reconstruct the original fund sequences and related information.

At step 508, process 500 (e.g., using control circuitry and/or one or more components described in FIGS. 1-4) inputs the first latent representation into a clustering layer of the machine learning model to generate a first clustering recommendation (e.g., a recommendation that identifies a specific cluster of a plurality of clusters into which to place the first domain). For example, the system may input the first latent representation into a clustering layer of the machine learning model to generate a first clustering recommendation for the first domain. For example, the clustering layer of the machine learning model may be trained to cluster domains based on respective time series data. For example, the latent representation of fund sequences may be fed into a clustering layer to group the fund sequences based on, e.g., NAV movements and long/short-term volatility.

At step 510, process 500 (e.g., using control circuitry and/or one or more components described in FIGS. 1-4) generates a network alert based on the first reconstruction and the first clustering recommendation. For example, the system may generate for display, on a user interface, a network alert based on the first reconstruction and the first clustering recommendation. For example, the network alert may indicate that the first reconstruction comprises an outlier from respective reconstructions of domains in the first cluster. Additionally or alternatively, the first clustering recommendation indicates that the first domain corresponds to a first cluster of a plurality of clusters.

In some embodiments, the system may determine clusters and generating reconstructions of time series data for multiple domains. For example, the system may receive second time-series data for a second domain for the first period of time. The system may generate a second feature input based on the second time-series data. The system may input the second feature input into the encoder portion of the machine learning model to generate a second latent representation. The system may input the second latent representation into a decoder portion of the machine learning model to generate a second reconstruction of the second time-series data. The system may input the second latent representation into the clustering layer of the machine learning model to generate a second clustering recommendation for the second domain. The system may determine to generate for display the network alert based on the first reconstruction and the second reconstruction.

In some embodiments, the system may also determine what reconstructions of time series data (and/or what domains to compare) based on a comparison of the reconstructions of time series data (and/or domains). For example, the system may generate the network alert based on a comparison of data from domains in the same cluster. For example, the system may compare the first clustering recommendation to the second clustering recommendation. The system may determine that the first clustering recommendation and the second clustering recommendation correspond to a first cluster of a plurality of clusters. The system may determine to base the network alert on the first reconstruction and the second reconstruction based on determining that the first clustering recommendation corresponds to the second clustering recommendation.

The system may compare data from multiple clusters in a variety of ways in order to determine whether or not to generate a network alert. For example, the system may average reconstructions of time series data for a cluster and compare it to reconstructions of time series data for a single domain within the cluster. In another example, the system may compare reconstructions of time series data for one domain to another. The system may then determine whether or not the difference equals or exceeds a threshold difference.

In another example, the system may determine a centroid value of the first cluster based on the first reconstruction and the second reconstruction. The system may determine a first distance of the first reconstruction from the centroid value. The system may compare the first distance to a threshold distance. The system may determine to generate for display the network alert based on the first distance equaling or exceeding the threshold distance. Additionally or alternatively, the system may determine a second distance of the second reconstruction from the centroid value. The system may compare the second distance to the threshold distance. The system may determine not to generate for display the network alert based on the second distance not equaling or exceeding the threshold distance. For example, the first distance is based on a Euclidean distance objective.

It is contemplated that the steps or descriptions of FIG. 5 may be used with any other embodiment of this disclosure. In addition, the steps and descriptions described in relation to FIG. 5 may be done in alternative orders, or in parallel to further the purposes of this disclosure. For example, each of these steps may be performed in any order, in parallel, or simultaneously to reduce lag, or increase the speed of the system or method. Furthermore, it should be noted that any of the devices or equipment discussed in relation to FIGS. 1-4 could be used to perform one of more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for generating network alerts based on detected variances in trends of domain traffic over a given time period for disparate domains in a computer network using machine learning models that generate cluster-specific temporal representations for time series sequences, the method comprising: receiving first time series data for a first domain for a first period of time; generating a first feature input based on the first time series data; inputting the first feature input into an encoder portion of a machine learning model to generate a first latent representation, wherein the encoder portion of the machine learning model is trained to generate latent representations of inputted feature inputs; inputting the first latent representation into a decoder portion of the machine learning model to generate a first reconstruction of the first time series data, wherein the decoder portion of the machine learning model is trained to generate reconstructions of inputted feature inputs; inputting the first latent representation into a clustering layer of the machine learning model to generate a first clustering recommendation for the first domain, wherein the clustering layer of the machine learning model is trained to cluster domains based on respective time series data; and generating for display, on a user interface, a network alert based on the first reconstruction and the first clustering recommendation.
2. The method of any proceeding claim, further comprising: receiving second time-series data for a second domain for the first period of time; generating a second feature input based on the second time series data; inputting the second feature input into the encoder portion of the machine learning model to generate a second latent representation; inputting the second latent representation into a decoder portion of the machine learning model to generate a second reconstruction of the second time-series data; inputting the second latent representation into the clustering layer of the machine learning model to generate a second clustering recommendation for the second domain; and determining to generate for display the network alert based on the first reconstruction and the second reconstruction.
3. The method of any proceeding claim, further comprising: comparing the first clustering recommendation to the second clustering recommendation; determining that the first clustering recommendation and the second clustering recommendation correspond to a first cluster of a plurality of clusters; and determining to base the network alert on the first reconstruction and the second reconstruction based on determining that the first clustering recommendation corresponds to the second clustering recommendation.
4. The method of any proceeding claim, wherein determining to generate for display the network alert based on the first reconstruction and the second reconstruction comprises: determining a centroid value of the first cluster based on the first reconstruction and the second reconstruction; determining a first distance of the first reconstruction from the centroid value; comparing the first distance to a threshold distance; and determining to generate for display the network alert based on the first distance equaling or exceeding the threshold distance.
5. The method of any proceeding claim, further comprising: determining a second distance of the second reconstruction from the centroid value; comparing the second distance to the threshold distance; and determining not to generate for display the network alert based on the second distance not equaling or exceeding the threshold distance.
6. The method of any proceeding claim, wherein the first distance is based on a Euclidean distance objective.
7. The method of any proceeding claim, wherein the machine learning model comprises an autoencoder constructed using a causal sequence convolutional neural network.
8. The method of any proceeding claim, wherein the first clustering recommendation indicates that the first domain corresponds to a first cluster of a plurality of clusters.
9. The method of any proceeding claim, wherein the network alert indicates that the first reconstruction comprises an outlier from respective reconstructions of domains in the first cluster.
10. The method of any proceeding claim, wherein the machine learning model maintains a time dependency for the first time series data.
11. A tangible, non-transitory, machine-readable medium storing instructions that, when executed by a data processing apparatus, cause the data processing apparatus to perform operations comprising those of any of embodiments 1-11.
12. A system comprising: one or more processors and memory storing instructions that, when executed by the processors, cause the processors to effectuate operations comprising those of any of embodiments 1-11.
13. A system comprising means for performing any of embodiments 1-11.

What is claimed is:

1. A system for generating network alerts based on detected variances in trends of domain traffic over a given time period for disparate domains in a computer network using machine learning models that generate cluster-specific temporal representations for time series sequences, the system comprising:
cloud-based storage circuitry configured to a machine learning model, wherein an encoder portion of the machine learning model is trained to generate latent representations of inputted feature inputs, wherein the machine learning model maintains a time dependency for time series data, wherein the machine learning model comprises an autoencoder constructed using a causal sequence convolutional neural network, wherein the encoder portion of the machine learning model is trained to generate latent representations of inputted feature inputs, wherein a decoder portion of the machine learning model is trained to generate reconstructions of inputted feature inputs, and wherein a clustering layer of the machine learning model is trained to cluster domains based on respective time series data;
control circuitry configured to:
receive first time series data for a first domain for a first period of time;
generate a first feature input based on the first time series data;
input the first feature input into an encoder portion of a machine learning model to generate a first latent representation;
input the first latent representation into a decoder portion of the machine learning model to generate a first reconstruction of the first time series data;
input the first latent representation into a clustering layer of the machine learning model to generate a first clustering recommendation for the first domain, wherein the first clustering recommendation indicates that the first domain corresponds to a first cluster of a plurality of clusters; and
input/output circuitry configured to:
generate for display, on a user interface, a network alert based on the first reconstruction and the first clustering recommendation, wherein the network alert indicates that the first reconstruction comprises an outlier from respective reconstructions of domains in a first cluster.

2. A method for generating network alerts based on detected variances in trends of domain traffic over a given time period for disparate domains in a computer network using machine learning models that generate cluster-specific temporal representations for time series sequences, the method comprising:
receiving first time series data for a first domain for a first period of time;
generating a first feature input based on the first time series data;
inputting the first feature input into an encoder portion of a machine learning model to generate a first latent representation, wherein the encoder portion of the machine learning model is trained to generate latent representations of inputted feature inputs;
inputting the first latent representation into a decoder portion of the machine learning model to generate a first reconstruction of the first time series data, wherein the decoder portion of the machine learning model is trained to generate reconstructions of inputted feature inputs;
inputting the first latent representation into a clustering layer of the machine learning model to generate a first clustering recommendation for the first domain, wherein the clustering layer of the machine learning model is trained to cluster domains based on respective time series data; and
generating for display, on a user interface, a network alert based on the first reconstruction and the first clustering recommendation.

3. The method of claim 2, further comprising:
receiving second time series data for a second domain for the first period of time;
generating a second feature input based on the second time series data;
inputting the second feature input into the encoder portion of the machine learning model to generate a second latent representation;
inputting the second latent representation into a decoder portion of the machine learning model to generate a second reconstruction of the second time-series data;
inputting the second latent representation into the clustering layer of the machine learning model to generate a second clustering recommendation for the second domain; and
determining to generate for display the network alert based on the first reconstruction and the second reconstruction.

4. The method of claim 3, further comprising:
comparing the first clustering recommendation to the second clustering recommendation;
determining that the first clustering recommendation and the second clustering recommendation correspond to a first cluster of a plurality of clusters; and
determining to base the network alert on the first reconstruction and the second reconstruction based on determining that the first clustering recommendation corresponds to the second clustering recommendation.

5. The method of claim 4, wherein determining to generate for display the network alert based on the first reconstruction and the second reconstruction comprises:
determining a centroid value of the first cluster based on the first reconstruction and the second reconstruction;
determining a first distance of the first reconstruction from the centroid value;
comparing the first distance to a threshold distance; and
determining to generate for display the network alert based on the first distance equaling or exceeding the threshold distance.

6. The method of claim 5, further comprising:
determining a second distance of the second reconstruction from the centroid value;
comparing the second distance to the threshold distance; and
determining not to generate for display the network alert based on the second distance not equaling or exceeding the threshold distance.

7. The method of claim 5, wherein the first distance is based on a Euclidean distance objective.

8. The method of claim 2. wherein the machine learning model comprises an autoencoder constructed using a causal sequence convolutional neural network.

9. The method of claim 2, wherein the first clustering recommendation indicates that the first domain corresponds to a first cluster of a plurality of clusters.

10. The method of claim 2, wherein the network alert indicates that the first reconstruction comprises an outlier from respective reconstructions of domains in the first cluster.

11. The method of claim 2, wherein the machine learning model maintains a time dependency for the first time series data.

12. A non-transitory, computer-readable medium for improving hardware resiliency during serial processing tasks in distributed computer networks using blockchains, comprising instructions that, when executed by one or more processors, cause operations comprising:
receiving first time series data for a first domain for a first period of time;
generating a first feature input based on the first time series data;
inputting the first feature input into an encoder portion of a machine learning model to generate a first latent representation, wherein the encoder portion of the machine learning model is trained to generate latent representations of inputted feature inputs;
inputting the first latent representation into a decoder portion of the machine learning model to generate a first reconstruction of the first time series data, wherein the decoder portion of the machine learning model is trained to generate reconstructions of inputted feature inputs;
inputting the first latent representation into a clustering layer of the machine learning model to generate a first clustering recommendation for the first domain, wherein the clustering layer of the machine learning model is trained to cluster domains based on respective time series data; and
generating for display, on a user interface, a network alert based on the first reconstruction and the first clustering recommendation.

13. The non-transitory, computer-readable medium of claim 12, wherein the instructions further cause operations comprising:
receiving second time-series data for a second domain for the first period of time;
generating a second feature input based on the second time series data;
inputting the second feature input into the encoder portion of the machine learning model to generate a second latent representation;
inputting the second latent representation into a decoder portion of the machine learning model to generate a second reconstruction of the second time-series data;
inputting the second latent representation into the clustering layer of the machine learning model to generate a second clustering recommendation for the second domain; and
determining to generate for display the network alert based on the first reconstruction and the second reconstruction.

14. The non-transitory, computer-readable medium of claim 13, wherein the instructions further cause operations comprising:
comparing the first clustering recommendation to the second clustering recommendation;
determining that the first clustering recommendation and the second clustering recommendation correspond to a first cluster of a plurality of clusters; and
determining to base the network alert on the first reconstruction and the second reconstruction based on determining that the first clustering recommendation corresponds to the second clustering recommendation.

15. The non-transitory, computer-readable medium of claim 14, wherein determining to generate for display the network alert based on the first reconstruction and the second reconstruction comprises:
determining a centroid value of the first cluster based on the first reconstruction and the second reconstruction;
determining a first distance of the first reconstruction from the centroid value;
comparing the first distance to a threshold distance; and
determining to generate for display the network alert based on the first distance equaling or exceeding the threshold distance.

16. The non-transitory, computer-readable medium of claim 15, wherein the instructions further cause operations comprising:
determining a second distance of the second reconstruction from the centroid value;
comparing the second distance to the threshold distance; and
determining not to generate for display the network alert based on the second distance not equaling or exceeding the threshold distance.

17. The non-transitory, computer-readable medium of claim 15, wherein the first distance is based on a Euclidean distance objective.

18. The non-transitory, computer-readable medium of claim 12, wherein the machine learning model comprises an autoencoder constructed using a causal sequence convolutional neural network, and wherein the machine learning model maintains a time dependency for the first time series data.

19. The non-transitory, computer-readable medium of claim 12, wherein the first clustering recommendation indicates that the first domain corresponds to a first cluster of a plurality of clusters.

20. The non-transitory, computer-readable medium of claim 12, wherein the network alert indicates that the first reconstruction comprises an outlier from respective reconstructions of domains in the first cluster.
